(19) United States
(12) Patent Application Publication
(10) Pub. No.: US 2021/0065222 A1
(43) Pub. Date: Mar. 4, 2021

(54) USER SENTIMENT METRICS

(71) Applicant: Microsoft Technology Licensing, LLC, Redmond, WA (US)

(72) Inventors: Eric Steven SCHUH, Seattle, WA (US); Adam Brett MAIDMAN, Seattle, WA (US); Vicky SVIDENKO, Newcastle, WA (US); Randy Jay PAGULAYAN, Seattle, WA (US); Daniel Victor GUNN, Redmond, WA (US)

(21) Appl. No.: 16/550,748

(22) Filed: Aug. 26, 2019

(51) Int. Cl. G06Q 30/02; G06Q 30/00; H04L 29/08; G06F 3/0482

(52) U.S. Cl. CPC G06Q 30/0203; G06Q 30/016; G06F 3/0482; H04L 67/306; H04L 67/34

(57) ABSTRACT

Techniques and systems for providing user sentiment metrics are described that can help assess user sentiment with experiences by creating user sentiment metrics that combine telemetry data with user research data in a manner that takes a memory aspect into consideration. A user sentiment metric service can manage a user history data resource. The user history data resource can include user history information associated with a user having a user identifier. The user history information can include a plurality of events, each event having an event identifier and a timestamp. The user sentiment metric service can generate, for a unit of time, a user sentiment metric for a user using events occurring prior to and during the unit of time. The events can include events obtained from the user history information. The user sentiment metric can apply the user sentiment metric to an application.

### BACKGROUND

Telemetry information can be collected to identify not only operations of a computing system, but also how certain software and software features are performing. Telemetry information can also be collected to identify how people interact with user interface (UI) and user experience (UX) designs. For example, telemetry systems associated with an e-commerce site can analyze server logs collected by the telemetry systems to determine how many people click on an item, how many people read the description, how many people added the item to their cart, and how many people completed the purchase.

However, using telemetry to determine the subjective experience—what aspects of that were painful? how painful was it? what aspects were delightful?—can be challenging. Many solutions involve counting errors or time spent and assume that errors are a proxy for pain and time spent is a proxy for positive engagement. And yet, not all errors are equally painful. For example, an error that prevents an advertisement from being displayed may be painless to an end user, whereas as error that prevents a user from successfully purchasing an item is quite painful. Similarly, time spent updating billing information may be less rewarding than time spent browsing products. Additionally, a user can experience more pain from frequently occurring errors. An error that only occurs once in a while may not be as painful as the same error that occurs every day.

### BRIEF SUMMARY

Techniques and systems for providing user sentiment metrics are described. The described techniques and systems can help assess user sentiment with experiences by creating user sentiment metrics that combine telemetry data with user research data to determine the user sentiment associated with different events seen in telemetry. The described user sentiment metric can provide a way of assessing user sentiment that includes behavioral and attitudinal data.

A user sentiment metric service can manage a user history data resource and sets of event parameters including a memory aspect that are based on user research data. The user history data resource can include user history information collected by any suitable telemetry service and that is stored associated with a user having a user identifier. The user history information can include a plurality of events, each event having an event identifier and a timestamp. The user sentiment metric service can generate, for a unit of time, a user sentiment metric for a user using events occurring prior to and during the unit of time and the appropriate corresponding event parameters. The events occurring prior to the unit of time and sometimes the events occurring during the unit of time can include events obtained from the user history information. The user sentiment metric service can apply the user sentiment metric to an application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conceptual diagram of techniques for providing user sentiment metrics according to an embodiment of the invention.

FIG. 2 illustrates an example sentiment function for generating a user sentiment metric according to an embodiment of the invention.

FIG. 3 illustrates an example operating environment in which various embodiments of the invention may be practiced.

FIG. 4 illustrates an example user sentiment metric service according to an embodiment of the invention.

FIGS. 5A-5C illustrate example processes for providing user sentiment metrics according to certain embodiments of the invention.

FIG. 6 illustrates components of an example computing system that may be used to implement certain methods and services described herein.

### DETAILED DESCRIPTION

Techniques and systems for providing user sentiment metrics are described. The described techniques and systems can help assess user sentiment with experiences by creating user sentiment metrics that combine telemetry data with user research data to determine the user sentiment associated with different events seen in telemetry. The described user sentiment metric can provide a way of assessing user sentiment that includes behavioral and attitudinal data.

User perception can be important to understand as developers attempt to build products that delight customers. Solutions that rely strictly on telemetry (e.g. time spent in product) or user research data (e.g., from customer satisfaction (CSAT) surveys and Net Promoter Score (NPS) surveys) do not allow for real-time assessment of user sentiment as a user engages with a product. The described techniques and systems result in a user sentiment metric that combines behavioral data collected through traditional telemetry data with attitudinal data collected, for example, through user research. This combination of behavioral data and attitudinal data can allow for a richer and more complete interpretation of the combined data and can show not only how a user reacts to an event, but also how a user perceives the event from his or her point of view.

Advantageously, the described techniques and systems go beyond simply combining telemetry information (e.g., error rates and engagement time) and user research data (e.g., customer satisfaction (CSAT) surveys and/or Net Promoter Score (NPS) surveys) by incorporating a memory aspect in a user sentiment metric. The memory aspect can be reflected in a memory parameter for the user sentiment metric. A memory parameter is a rate of decay of user emotional response to an event.

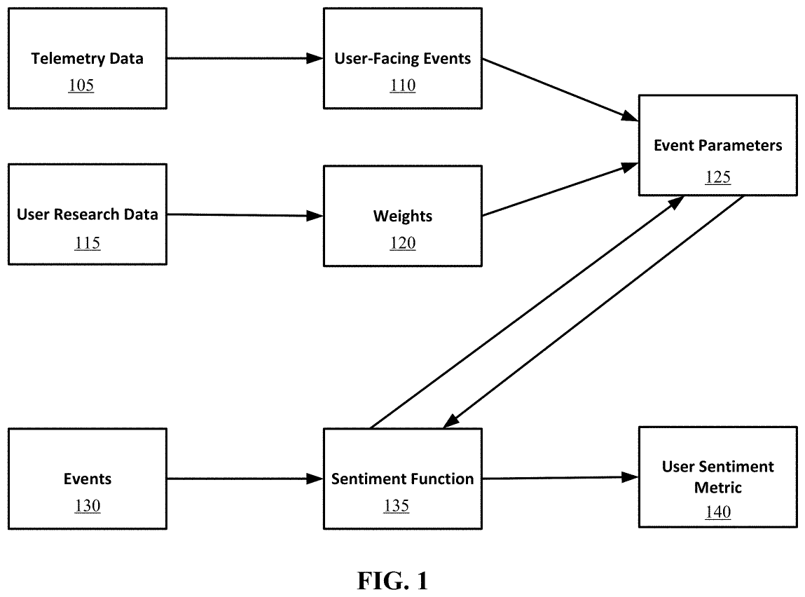

FIG. 1 illustrates an example conceptual diagram of techniques for providing user sentiment metrics according to an embodiment of the invention. Referring to FIG. 1, telemetry data 105 (e.g., behavioral data) can be combined with user research data 115 (e.g., attitudinal data) to generate event parameters 125.

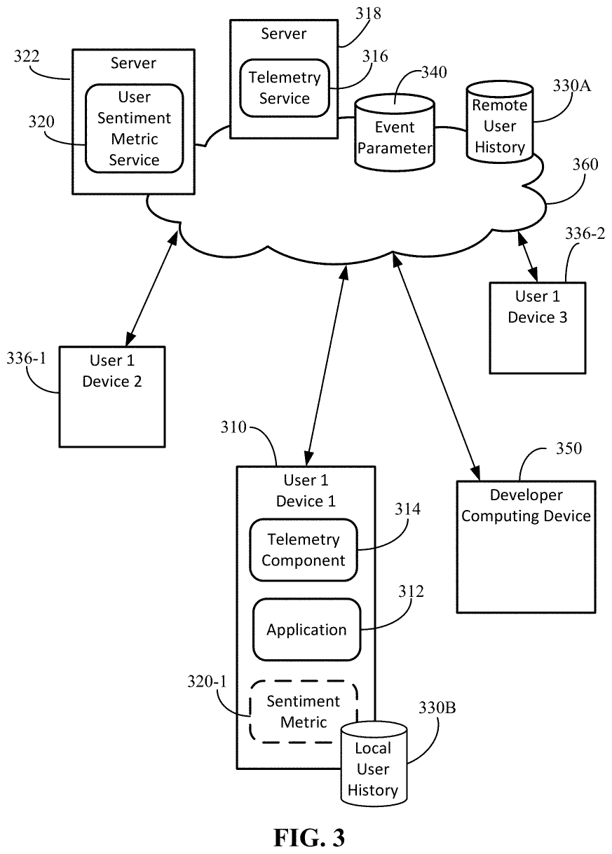

The telemetry data 105 may be collected from telemetry messages received from multiple clients (see e.g., FIG. 3). A “telemetry message” is a signal from a client containing one or more kinds of telemetry data. Telemetry messages can include error logs, error information from debuggers, usage data logs, and performance data. A telemetry message contains an indicator of the source of the telemetry, identifying, for example, the device, user, application, component, license code, subdivision or category within an application or component, or other information that is the origin of the telemetry message.

A telemetry message also contains “state information,” or information about the conditions or circumstances surrounding, e.g., the error or usage data. The state information can vary widely by the type of telemetry message and the system, and holds information ranging from a simple numeric code to a detailed log of activities or events occurring at a point in time or over a time period. Some example types of telemetry message state include log data, event data, performance data, usage data, crash reports, bug reports, stack traces, register states, heap states, processor identifiers, thread identifiers, and application or component-level try/catch block exceptions. Telemetry message state can also include real-time performance information such as network load or processor load. It should be noted that these types of telemetry message states are merely exemplary and that any type of information that could be gathered from a device can potentially be contained in the telemetry message state, depending on the logging or telemetry capabilities of the device, application, or components. Naturally, a particular telemetry message's state information can include more than one type of state information.

In many cases a code or description, for example an error code or description, is included in the telemetry message that identifies the problem, event, or operation with a high degree of granularity. Sometimes, an error code or description is identified by the operating system, and sometimes an error code or description is specific to a particular application or component; in the latter case, a source identifier specifying the component may be required to discern the error condition. The code or description may be part of what is referred to herein as an “event identifier.”

It should be understood that telemetry collection rules follow privacy protocols and permissions (set by the service, user, or client device) to restrict or narrow access to private information.

The telemetry data 105 is analyzed to determine user-facing events (“events”) 110. User-facing events 110 are events or experiences the user can see and can include negative, neutral, and positive events.

Negative events may be determined by identifying which errors result in a disruption of a user experience (e.g., a “painful” experience). For example, an error is a user-facing event if the result of the error means that the user either must press a button to re-try the experience or do something else.

Positive events can include events that do not result in a disruption of the user experience. Examples of positive events may include, but are not limited to, successfully launching an application and successfully performing activities inside the application (e.g., saving a document and joining a party chat). Positive events may also include reaching a level, finding loot, and scoring points in a game.

User research data 115 can be used to determine weights 120 associated with each of the user-facing events 110. The user research data 115 can provide an understanding of user sentiment and can be used to determine the weights 120 associated with different aspects of a user experience (e.g., event). The weights 120 for each event can include, but are not limited to, the initial emotional response (e.g., impact) of an event, how long the emotional response of the event lasts, and what the emotional response of repeated events is.

There are many research methods for determining user sentiment with an experience (e.g., event) including, but not limited to, interviews, focus groups, surveys, KANO studies, eye gaze analysis, and so forth. There are many different ways this sentiment can be collected including, but not limited to, in person, via email, via the web, via phone calls, via in-product experiences (e.g., star ratings). Any of these techniques can be employed to get a detailed understanding of the user sentiment associated with different aspects of a user experience (e.g., event). This includes, but is not limited to, perceptions of different errors (e.g., negative events), different successes (e.g., positive events), and time spent doing different activities.

Regardless of the specific research method or specific mechanism for collecting the user research data 115, the user research data 115 can be used to understand how painful and how rewarding different aspects of the user experience (e.g., events) are and how long these effects last.

In some cases, weights may be determined by conducting surveys where users are given descriptions of different negative and positive events. The negative events and the positive events may be presented in different groups or combinations. For example, 20 negative events may be shown to a set of users in different combinations. For each of the different combinations, the set of users can identify which of those events is most painful and which of those events is least painful.

The results of the surveys may be analyzed to form weights, such as Bayesian weights. The weights may then be mapped to different events. In some cases, the weights may be a number. In some cases, each event may be categorized into different levels of pain, such as high pain, medium pain, and low pain and given a value.

In some cases, the weights 120 can be determined through other mechanisms, such as any suitable machine learning, or neural network, or other artificial intelligence process.

Event parameters 125 may be generated for each of the user-facing events 110 based on the associated weights 120. Each event parameter can be stored with a corresponding event having an event identifier. The event parameters 125 include, but are not limited to, an initial emotional response parameter, a multiplier parameter, and a memory parameter. As mentioned above, the memory parameter is a rate of decay of user emotional response to an event.

The initial emotional response parameter can be based on the weight of the initial impact of an event. More positive events or more negative events can have larger initial emotional responses than less positive events or less negative events. For example, an event including an error loading an operating system, such as Microsoft Windows or Apple iOS, may have a larger initial emotional response parameter than an event including an error loading an advertisement because an error loading the operating system can prevent a user from doing any activity.

The multiplier parameter can be based on the weight of the impact of repeated events (e.g., a multiplier effect for frequently occurring events).

The memory parameter can be based on the weight of how long the impact of the event lasts. The memory parameter can help incorporate the idea that persistent errors are more painful by determining how much time it takes a user to stop being bothered by an error. Happiness (or pain) may be a journey for a user. An error that happens only once may be quickly forgotten, whereas a persistent error can become increasingly aggravating each instance. To account for this complexity, the user sentiment metric includes a memory aspect, which can be captured mathematically as a decay curve and shown in the user sentiment by including the memory parameter and the multiplier parameter.

As an example of a negative event, an inciting event can cause pain, but that pain can decay over time until the user is back in their resting state. Repeated errors can increase the pain and lengthen the amount of time it takes the user to return to the resting state.

The same applies to events that bring pleasure. In an example of a positive event, the positive event brings happiness, but the happiness decays over time. And repeated positive events can increase the happiness and lengthen the amount of time it takes to return to the resting state.

A user sentiment metric for a user (e.g., user sentiment metric 140) can be generated for a unit of time based on the events (e.g., events 130) occurring prior to and during the unit of time.

The events 130 can be obtained for a user. Each event of the events 130 includes at least an event identifier and a timestamp. The events 130 can include events obtained from telemetry data and/or user history information for the user. For example, events occurring during the unit of time may be obtained from telemetry data and events occurring prior to the unit of time may be obtained from the user history information for the user.

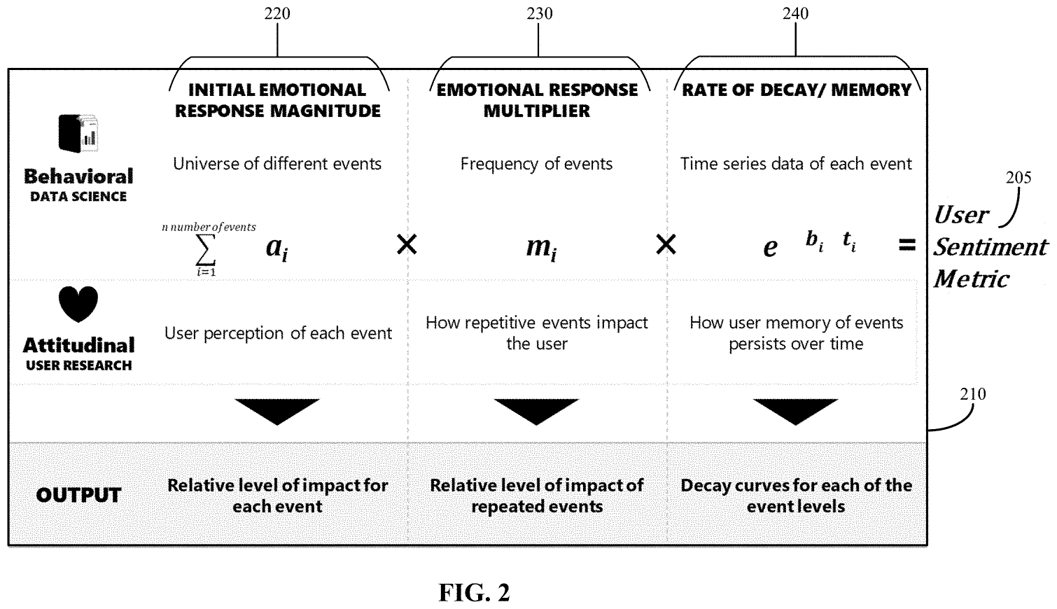

For each event of the events 130, corresponding event parameters are obtained from the event parameters 125 and applied to sentiment function 135 to generate a user sentiment metric 140. An example of the sentiment function 135 will be discussed in more detail with respect to FIG. 2.

Since the events 130 includes events occurring prior to the unit of time, the user sentiment metric 140 can include a memory component. That is, the user sentiment metric 140 is not using each event in isolation. Instead, the user sentiment metric 140 represents the journey that the user has as the user is engaging with a product.

FIG. 2 illustrates an example sentiment function for generating a user sentiment metric according to an embodiment of the invention. Referring to FIG. 2, for a given user during any given unit of time, a user sentiment metric 205 can be generated by summing up event scores from each event (of the set of events involving events prior to and during the unit of time) using a sentiment function 210. If the event happened in the past, then it contributes to the overall user sentiment metric after dulling the effect (e.g., “memory”).

For the sentiment function 210, let n be all the events that a user has had recently. Let i=1, . . . , n denote a specific recent event and let aᵢ be the initial emotional response parameter from the i^{th} event, such as the initial emotional response parameter described with respect to FIG. 1. Let mᵢ be a multiplier parameter for the i^{th} event, such as the multiplier parameter described with respect to FIG. 1. The multiplier parameter may be greater than 1 if the event happens in succession (e.g., the same error occurs repeatedly). Let bᵢ be the rate of decay (determined by memory parameter, such as the memory parameter described with respect to FIG. 1) for the i^{th} event. Lastly, let tᵢ be the time since the i^{th} event has occurred.

The formula for an event score for one event is

aᵢ·mᵢ·e^{b}^{ᵢ}^{·t}^{ᵢ}

To get the overall score for a user for a unit of time, such as a day, each event score is summed up using the sentiment function, as described with respect to FIG. 1.

Score=Σᵢ₌₁ⁿaᵢ·mᵢ·e^{b}^{ᵢ}^{·t}^{ᵢ}

Advantageously, the user sentiment metric allows for a real time, or in the moment, indication of user sentiment for a user without having to rely on direct user feedback. For example, the user does not have to fill out a survey; and the user sentiment metric service does not have to wait for the user to fill out a survey.

As previously mentioned with respect to FIG. 1, behavioral data (e.g., telemetry data) can be combined with attitudinal data (e.g., user research data) to generate event parameters (e.g., event parameters 125) for the sentiment function 210.

The initial emotional response magnitude 220 can include the initial emotional response parameter (given as aᵢ, representing the value of the emotional response for event i). The initial emotional response magnitude 220 is based on both the behavioral data and the attitudinal data, where the behavioral data includes the universe of different events (i.e., all known/possible events) and the attitudinal data includes a user perception of each event. The output of the combination of the behavioral data and the attitudinal data includes the relative level of impact (e.g., emotional response) for each event. This relative level of impact of each event is reflected in the user sentiment metric 205 as the initial emotional response parameter (e.g., aᵢ).

The emotional response multiplier 230 can include the multiplier parameter (given as mᵢ, representing the value of the multiplier for event i). The emotional response multiplier 230 is based on both the behavioral data and the attitudinal data, where the behavioral data includes the frequency of events and the attitudinal data includes how repetitive events impact the user. The output of the combination of the behavioral data and the attitudinal data includes the relative level of impact (e.g., emotional response) of repeated events. This relative level of impact of repeated events is reflected in the user sentiment metric 205 as the multiplier parameter (e.g., mᵢ).

The rate of decay/memory 240 can include the memory parameter (given as bᵢ, representing the value of the memory for event i) and a time parameter (given as tᵢ, which indicates the amount of time that has passed for event i). The rate of decay/memory 240 is based on both the behavioral data and the attitudinal data, where the behavioral data includes the time series data of each event and the attitudinal data includes how user memory of events persists over time. The output of the combination of the behavioral data and the attitudinal data includes the relative level of impact over time and can be represented as decay curves for each of the event levels. These decay curves are reflected in the user sentiment metric 205 as e^{b}^{ᵢ}^{t}^{ᵢ}.

FIG. 3 illustrates an example operating environment in which various embodiments of the invention may be practiced. Referring to FIG. 3, a user may interact with a user computing device 310 running an application, such as application 312. User computing device 310 may be a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen.

User computing device 310 can include a telemetry component 314 for assembling and sending telemetry messages to a telemetry service 316. As previously described, telemetry messages can include error logs, error information from debuggers, usage data, and performance data.

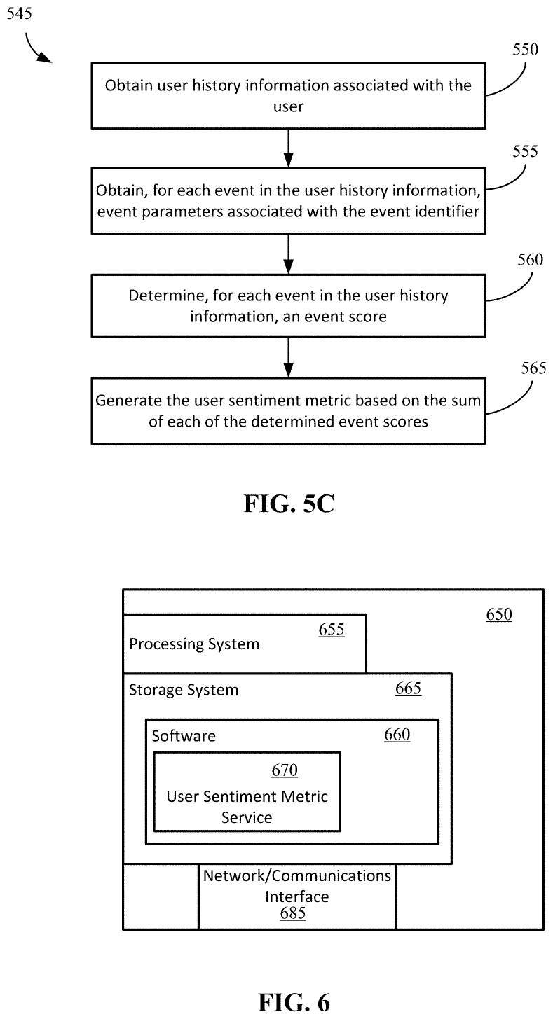

Telemetry service 316 may be implemented as software or hardware (or a combination thereof) on server 318, which may be an instantiation of system 600 as described in FIG. 6. Telemetry messages from user computing device 310 may be directed to telemetry service 316 via an application programming interface, or via another messaging protocol. It should be understood that telemetry collection rules follow privacy protocols and permissions (set by the service, user, or client device) to restrict or narrow access to private information.

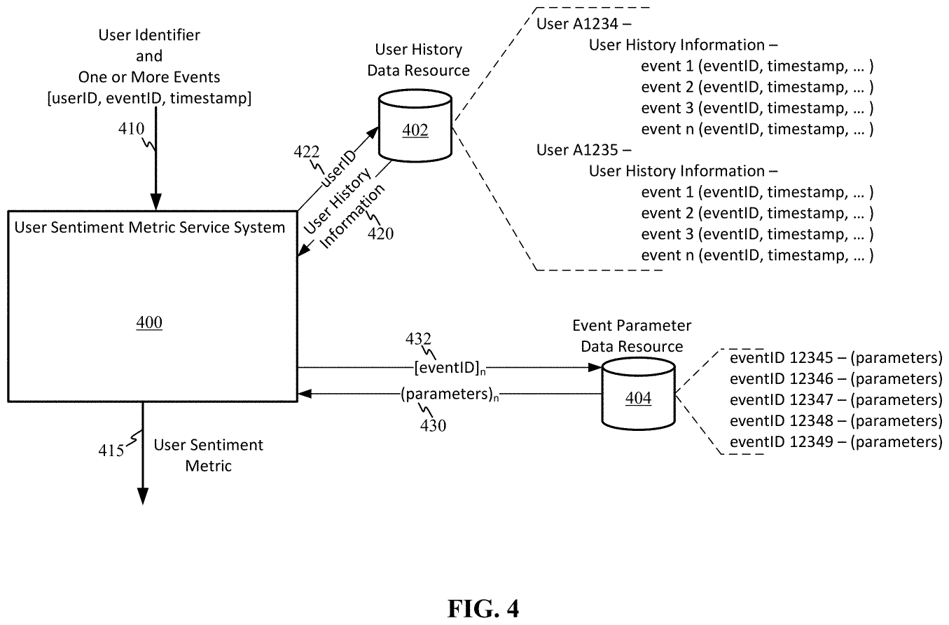

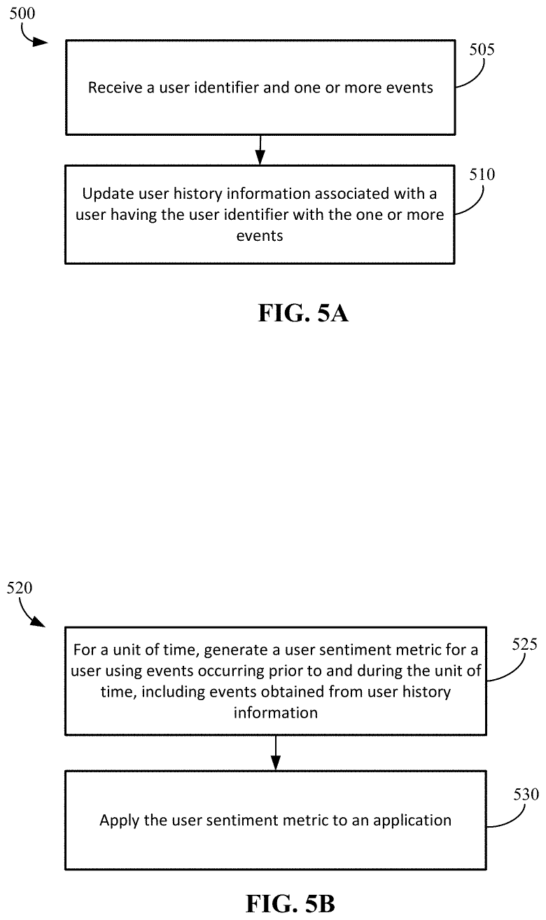

User sentiment metric service 320 may receive information, such as events and associated user identifiers from telemetry service 316. User sentiment metric service 320 can carry out processes 500, 520, and 545 (which may operate similar to that described with respect to FIG. 4). User sentiment metric service 320 may be implemented as software or hardware (or a combination thereof) on server 322, which may be an instantiation of system 600 as described in FIG. 6. In some cases, some or all of the features carried out by user sentiment metric service 320 are carried out at computer device 310 via user sentiment metric component 320-1. In the case of user sentiment metric component 320-1 operating at the user computing device, user sentiment metric component 320-1 can receive telemetry data from telemetry component 315 and can perform some or all of process 500, 520, and 545 as described with respect to FIGS. 5A-5C. User sentiment metric component 320-1 may provide immediate user sentiment metric data to application 312. In response to receiving immediate user sentiment metric data from user sentiment metric component 320-1, the application 312 can provide real-time adjustments.

The information (e.g., events and associated user identifiers) received from the telemetry service 316 may be stored as user history information in a user history data resource 330 (e.g., local user history data resource 330A and/or remote user history data resource 330B).

In some embodiments, user history information is increased by collecting telemetry data from the same user across devices, such as across devices 310, 336-1, and 336-2. The second device 336-1 and third device 336-2 may include the same types of devices (or systems) as user computing device 310 and they may or may not be of a same form. For example, a user may have a laptop, a tablet, and a smart phone as the three devices. The across-device collection can be carried out, for example, where a user signs in to use a program or accesses the program from a client device communicating with a server running the application. In some embodiments where a user uses a same product or program on multiple devices, telemetry data within one session on one computing device may be combined with telemetry data within a session on another computing device in order to capture additional user history information from the user.

Event parameter data resource 340, associated with server 322 or accessible through the cloud, may store event parameters as structured data. For example, the data set stored at the event parameter data resource 340 may be populated with event parameters for each of a plurality of events, such as event parameters 125, as described with respect to FIG. 1.

The information received, collected, and/or generated by the user sentiment metric service 320 (such as found in the user history data resource 330 and/or the event parameter data resource 340) may be stored on a same or different resource and even stored as part of a same data structure depending on implementation.

A developer may have access to data generated by the user sentiment metric service 320, such as user sentiment metrics, through developer computing device 350. Such data might be useful to developers for refining features or user interfaces. The data may also be useful to other parties, such as product designers and customer service representatives. The user sentiment metrics may be available through applications that can provide visual representations of the data (and enable exploration of the data). The developer computing device 350 may include the same type of device (or system) as user computing device 310.

Components (computing systems, storage resources, and the like) in the operating environment may operate on or in communication with each other over a network 360. The network 360 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 360 may include one or more connected networks (e.g., a multi-network environment) including public networks, such as the Internet, and/or private networks such as a secure enterprise private network. Access to the network 360 may be provided via one or more wired or wireless access networks as will be understood by those skilled in the art.

As will also be appreciated by those skilled in the art, communication networks can take several different forms and can use several different communication protocols. Certain embodiments of the invention can be practiced in distributed-computing environments where tasks are performed by remote-processing devices that are linked through a network. In a distributed-computing environment, program modules can be located in both local and remote computer-readable storage media.

Communication to and from the components may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

FIG. 4 illustrates an example user sentiment metric service according to an embodiment of the invention; and FIGS. 5A-5C illustrate example processes for providing user sentiment metrics according to certain embodiments of the invention.

Referring to FIG. 4, a user sentiment metric service performing one or more processes, such as process 500, 520, and 545 as illustrated in FIGS. 5A-5C, can be implemented by a system 400 such as described with respect to server 322 of FIG. 3, which can be embodied as described with respect to computing system 600 as shown in FIG. 6, and even, in whole or in part, by a user computing device (e.g., as part of user sentiment metric component 320-1).

System 400 may include or communicate with one or more resources such as a user history data resource 402 and an event parameter data resource 404, each of which may store data sets. It should be understood that these data sets may be stored on a same or different resource and even stored as part of a same data structure.

The user history resource 402 may comprise user history information associated with a user having a user identifier. The user history information for each user can include, but is not limited to, a plurality of events, each event having an event identifier and a timestamp.

The event parameter data resource 404 may contain a plurality of events and associated event parameters, such as event parameters 125 as described with respect to FIG. 1. The event parameters can include, but are not limited to, an emotional response parameter, a multiplier parameter, and a memory parameter.

Components (computing systems, data resources, and the like) in the operating environment may operate on or in communication with each other over a network such as described with respect to network 360 of FIG. 3. Certain implementations of the described user sentiment metric service can be practiced in distributed-computing environments where tasks are performed by remote-processing devices that are linked through a network. In a distributed-computing environment, program modules can be located in both local and remote computer-readable storage media. Communication to and from system 400 may be carried out, in some cases, via APIs.

Referring to both FIG. 4 and FIG. 5A, a user sentiment metric service, such as implemented by system 400, manages the user history data resource 402 and can receive (505) information 410 such as a user identifier and one or more events. Each of the one or more events received includes a corresponding event identifier and timestamp.

The user sentiment metric service uses the received information 410 to update (510) user history information associated with a user having the user identifier with the one or more events. The one or more events (having the corresponding event identifier and timestamp) are added to the user history information stored in the user history data resource 402.

Referring to both FIG. 4 and FIG. 5B, a user sentiment metric service, such as implemented by system 400, manages the user history data resource 402 and can, for a unit of time, generate (525) a user sentiment metric 415 for a user. The user sentiment metric service can generate the user sentiment metric 415 for the user using events occurring prior to and during the unit of time. The unit of time can be any suitable unit of time. The events occurring at least prior to the unit of time can be obtained from user history information stored in the user history data resource 402. In some cases, events occurring during the unit of time can also be obtained from the user history data resource. In some cases, such as for real-time sentiment analysis, the events occurring during the unit of time are at least temporarily stored in a cache or other storage at system 400.

In some cases, the unit of time can be a day. For example, the user sentiment metric service can update the user sentiment metric 415 for a user ever day by generating the user sentiment metric 415 for a user every 24 hours.

In an example where the unit of time is a day (i.e., a 24-hour period), the user sentiment metric service can generate the user sentiment metric 415 using events that have occurred during that 24-hour period for the user, as well as events occurring prior to that 24-hour period for the user. In some cases, the user sentiment metric service can communicate with the user history data resource 402 to obtain the events occurring prior to and during the 24-hour period from the user history information for the user.

In some cases, the unit of time is a time of a timestamp of a received event. In this case, each time a new event is received, the user sentiment metric service can generate the user sentiment metric 415.

In some cases, the events being used to generate the user sentiment metric 415 (e.g., the events occurring prior to and during the unit of time) may be subject to a threshold. That is, instead of using every event stored in the user history information, the user sentiment metric service may only user a portion of events to generate the user sentiment metric 415. In some cases, the threshold may be a certain number of events (e.g., 25, 100, or 1000) having occurred prior to the unit of time. For example, the user sentiment metric service may use the events occurring during the unit of time, as well as the most recent 100 events occurring prior to the unit of time, to generate the user sentiment metric 415.

In some cases, the threshold may be a certain amount of time (e.g., one week, one month, or one year) prior to the unit of time. For example, the user sentiment metric service may use events occurring during the unit of time, as well as the events occurring in the one month prior to the unit of time, to generate the user sentiment metric 415.

The user sentiment metric service can apply (530) the user sentiment metric 415 to an application. The user sentiment metric 415 can be applied to an application in a variety of ways. In some cases, the user sentiment metric 415 can be provided to an application.

When a developer makes changes to a product, the developer may want to see what impact the changes will have on users. The user sentiment metric 415 can be applied to an application to help understand this impact.

In some cases, the applying of the user sentiment metric 415 to the application comprises applying the user sentiment metric 415 to an A/B test. Applying the user sentiment metric 415 to an A/B test can help to make sure that the developer is not making users more unhappy by introducing changes.

In some cases, user sentiment metric 415 can be a key performance indicator (KPI) that is tracked over time. For example, the user sentiment metric 415 can be reported to a leadership dashboard.

In some cases, the user sentiment metric 415 can be applied to an application to help identify different classes of users. For example, the user sentiment metric 415 can be used to identify that a user is highly engaged but also highly pained. Thus, if a user that is identified as a highly engaged but also highly pained user calls support, the support representative can have that user escalated to a higher support level.

In some cases, the user sentiment metric 415 can be applied to an application to provide proactive help recommendations. For example, if the user sentiment metric 415 identifies that a user is in pain because the NAT settings on the user's router aren't consistent with what the user is trying to achieve, proactive help solutions can be provided to the user.

Since engineering resources are finite, engineers and/or developers often need to determine where to best allocate available hours and resources to fixing problems. Engineering teams can use the user sentiment metric 415 to help understand not only how many errors people are getting, but how users are feeling about those errors. The user sentiment metric 415 can help engineering teams decide which problems the engineering team wants to fix based on how users are feeling about the problems that are happening to them. Thus, the user sentiment metric 415 can provide a user centric view of errors as opposed to an engineering centric view.

Referring to both FIG. 4 and FIG. 5C, a user sentiment metric service, such as implemented by system 400 can perform process 545, which is an example implementation of, for a unit of time, generating a user sentiment metric 415 for a user using events occurring prior to and during the unit of time (i.e., step 525 as described with respect to FIG. 5B).

To generate the user sentiment metric 415 for the user, the user sentiment metric service can obtain (550) user history information 420 associated with the user. In some cases, the user sentiment metric service can communicate a user identifier 422 of the user to the user history data resource 402 and receive the user history information 420 of the user having the user identifier. In some cases, the system 400 performs a lookup of the user history information using the user identifier 422. The user history information 420 can include all previously stored events (subject to an optional threshold) for the user, with each event having at least an event identifier and a timestamp.

For each event in the user history information 420, the user sentiment metric service can obtain (555) event parameters 430 associated with the event identifier. In some cases, the user sentiment metric service can communicate the event identifier 432 for each of the events to the event parameter data resource 404 and receive the event parameters 430 associated with each event identifier 432. In some cases, the system 400 performs a lookup of the event parameter data resource using the event identifier 432.

The event parameters 430, such as event parameters 125 described with respect to FIG. 1, can include an emotional response parameter, a multiplier parameter, and a memory parameter for each event. The initial emotional response parameter can be based on the weight of the initial impact of an event. More positive events or more negative events can have larger initial emotional responses than less positive events or less negative events. The multiplier parameter can be based on a frequency of an event in the user history information. For example, the multiplier parameter may be based on how many times the event has occurred within the user history. In some cases, if a user encounters the same event multiple times, the multiplier parameter may be larger for that event and smaller for an event that has only occurred once. In some cases, the multiplier parameter will be 1 if the event has only occurred once and greater than 1 if the event has occurred multiple times. The memory parameter may be a rate of decay of user emotional response to an event. In some cases, the memory parameter can be based on the weight of how long the impact of the event lasts. The memory parameter can help incorporate the idea that persistent/continued errors are more painful/negative by determining how much time it takes a user to stop being bothered by an error.

The user sentiment metric service can determine (560) an event score for each event based on the obtained event parameters 430 and an amount of time from the timestamp. In some cases, the event score for an event can be determined using the formula described with respect to FIG. 2 (i.e., event score for event i, ESᵢ=aᵢ·mᵢ·e^{b}^{ᵢ}^{·t}^{ᵢ}).

The user sentiment metric service can generate (565) the user sentiment metric 415 based on the sum of each of the determined event scores. In some cases, the user sentiment metric 415 can be generated using a sentiment function, such as sentiment function 135 as described with respect to FIG. 1.

Advantageously, the user sentiment metric does not use events in isolation. Instead, the user sentiment metric considers the journey that a user has as the user is going through their experience and includes memory. Thus, if the user encounters the same event (e.g., an error) multiple times, each time the event occurs may have more or less of an emotional response and includes a decay curve where the user eventually stops feeling an emotional response from the event.

As an illustrative example, a first event happens to a user on Day 1. At the time of the first event (i.e., no time has passed), the user has an initial emotional response to the first event, either in the positive direction or in the negative direction depending on whether the experience by the user of the event was positive or negative (e.g., painful). The initial emotional response is the first event's contribution to the user sentiment metric for the user for Day 1. In this example, the first event is an error and is considered a negative event with a negative initial emotional response.

On Day 2, the user likely remembers the negative experience from that first event the previous day (e.g. Day 1), but is now a day removed from that first event. The first event may not be affecting the user in the same way, thus, the emotional response may be, for example, cut in half. Advantageously because of the memory aspect of the described techniques and systems, the user sentiment metric for the user for Day 2 would have a contribution from the first event from Day 1 and then any new events that occur on Day 2.

Continuing with the illustrative example, a second event may occur on Day 3 that has the same event identifier as the first event. Based on user research, this event may be one that has been found to fall into the category of events of frequent errors and other negative events that keep occurring that users indicate that they get annoyed with. The emotional response the second time the event occurs may be bigger than the initial emotional response the first time the event occurred. Thus, the multiplier parameter having a value greater than 1 is provided from the event parameter data resource in the case of the second event to show the event is more painful each successive time.

The user sentiment metric for the user for Day 3 would have a contribution from the first event from Day 1, any events that occurred on Day 2, and the second event from Day 3.

### Additional Example Scenario

As an additional example scenario, user sentiment metrics can be applied to a video game platform, such as Microsoft Xbox Live. As a first step, macro experiences (e.g., events) that a user may complete as the user goes through the process of enjoying a video game, such as account settings, broadcasting, digital delivery, game save, hardware, launching and installing games, multiplayer, network, purchase content, sign-in, and system update, can be identified. Many of these macro experiences have several micro experiences (e.g., events) that are actions within the broader context of the macro experience (e.g., party chat is a micro experience within multiplayer). In these experiences, many requests from the video game console are sent to the video game service. An error occurs when a request from the console is not successfully completed. Many errors can occur during this process and often, a request is automatically re-submitted until successful. As a result, the user does not notice any failures.

Errors that result in a disruption of the experience (e.g., user-facing errors) can be identified. An error is a user-facing error if the result of the error means that the user either must press a button to re-try the experience or do something else. The user-facing errors can be tracked for these 22 micro experiences for each user. In addition to user-facing errors, toxic messages (hateful messages) that a user receives can also be tracked. Though a toxic message is not an error, it can cause pain to a user and diminish the happiness that the user might have experienced without receiving a toxic message.

In addition to learning about pain caused by errors, user research may also be conducted to learn about how much satisfaction or happiness is gained from successful completion of these experiences (e.g., events) or from positive messages.

Next, the time a user is engaged with the video game can be estimated. The time can be estimated by recording the time that the video game sends a signal to the monitor to stay awake. This occurs when a user presses a button or watches a streaming app, such as Mixer, which signals the monitor to stay awake even if the user does not give any inputs to the system. The data from recording engaged time and user-facing errors may be different from traditional hardware telemetry because the experience of the gamer is being estimated, whereas traditional telemetry captures inputs and outputs from the console. Traditional telemetry may not be sufficient to determine the time a user is engaged because features like Instant-On, automatic updates, and the ability of a user to walk away from the monitor without turning off the console can result in over-estimating the time a user is actually engaged.

To estimate the impact of user-facing errors in different experiences, video game users can be interviewed. Based on their responses, the user-facing errors that caused more impact than others can be determined. Because not all errors cause the same amount of impact, errors in different experiences (e.g., events) have different weights. For example, an error with sign-in may be twice as painful as an error with purchase content. Thus, the sign-in error may be assigned a weight of “2” while the purchase content error is assigned a weight of “1”.

The user sentiment metric can be generated for each video game user. Throughout the course of a day, a user goes through many of these experiences. If a user successfully completes an experience (e.g. launches a game, joins a party chat, etc.) the user can receive positive points (these points are determined by user research), such as event scores with positive values. On the other hand, if a user encounters an error or toxic message, the user receives negative points, such as event scores with negative values. Adding up these points for a gaming session or day gives a single score (i.e., the user sentiment metric) for each user per gaming session or day. The results of these scores can be applied to any suitable application. For example, the user sentiment metric may be provided in a dashboard for the game in order for the developer to identify where there could be problems. As another example, the user sentiment metric may be fed back to the game to cause a dynamic adjustment of certain features of the game for the user.

FIG. 6 illustrates components of an example computing system that may be used to implement certain methods and services described herein. Referring to FIG. 6, system 650 may be implemented within a single computing device or distributed across multiple computing devices or sub-systems that cooperate in executing program instructions. Accordingly, more or fewer elements described with respect to system 650 may be incorporated to implement a particular system. The system 650 can include one or more blade server devices, standalone server devices, personal computers, routers, hubs, switches, bridges, firewall devices, intrusion detection devices, mainframe computers, network-attached storage devices, and other types of computing devices.

In embodiments where the system 650 includes multiple computing devices, the server can include one or more networks that facilitate communication among the computing devices. For example, the one or more networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

System 650 can include processing system 655 of one or more processors to transform or manipulate data according to the instructions of software 660 stored on a storage system 665. Examples of processors of the processing system 655 include general purpose central processing units (CPUs), graphics processing units (GPUs), field programmable gate arrays (FPGAs), application specific processors, and logic devices, as well as any other type of processing device, combinations, or variations thereof.

Software 660 can include an operating system, applications, and services, such as user sentiment metric service 670; and user sentiment metric service 670 may perform some or all of process 500, 520, and 545 as described with respect to FIGS. 5A-5C.

Storage system 665 may comprise any suitable computer readable storage media. Storage system 665 may include volatile and nonvolatile memories, removable and non-removable media implemented in any method or technology for storage of information, such as computer readable instructions, data structures, program modules, or other data. Examples of storage media of storage system 665 include random access memory, read only memory, magnetic disks, optical disks, CDs, DVDs, flash memory, magnetic cassettes, magnetic tape, magnetic disk storage or other magnetic storage devices, or any other suitable storage media. In no case do storage media consist of transitory, propagating signals.

Storage system 665 may be implemented as a single storage device but may also be implemented across multiple storage devices or sub-systems co-located or distributed relative to each other. Storage system 665 may include additional elements, such as a controller, capable of communicating with processing system 655.

Network/communication interface 685 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed by hardware of the computer system (e.g., a processor or processing system), can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
managing, through a computing system, a user history data resource, the user history data resource comprising user history information associated with a user having a user identifier, the user history information comprising a plurality of events, each event having an event identifier and a timestamp;
for a unit of time, generating, via the computing system, a user sentiment metric for the user using events occurring prior to and during the unit of time, including events obtained from the user history information; and
applying the user sentiment metric to an application.

2. The method of claim 1, further comprising:
receiving the user identifier of the user and one or more events; and
updating the user history information associated with the user in the user history data resource with the one or more events.

3. The method of claim 1, wherein the generating of the user sentiment metric for the user comprises:
obtaining the user history information associated with the user;
for each event in the user history information:
obtaining event parameters associated with the event identifier; and
determining an event score for the event based on the obtained event parameters and an amount of time from the timestamp; and
generating the user sentiment metric based on a sum of each of the determined event scores.

4. The method of claim 3, wherein the event parameters comprise an initial emotional response parameter, a multiplier parameter, a memory parameter, or a combination thereof

5. The method of claim 4, wherein the multiplier parameter is based on a frequency of an event in the user history information.

6. The method of claim 4, wherein the memory parameter is a rate of decay of user emotional response to an event.

7. The method of claim 1, wherein the unit of time is a day.

8. The method of claim 1, wherein the unit of time is a time of a timestamp of a received event, such that each time a new event is received, the user sentiment metric is generated.

9. The method of claim 1, wherein the applying of the user sentiment metric to the application comprises applying the user sentiment metric to an A/B test.

10. The method of claim 1, wherein the applying of the user sentiment metric to the application comprises determining a class for the user based on the user sentiment metric.

11. A computer-readable storage medium having instructions stored thereon that, when executed by a processing system, perform a method comprising:
managing a user history data resource, the user history data resource comprising user history information associated with a user having a user identifier, the user history information comprising a plurality of events, each event having an event identifier and a timestamp;
for a unit of time, generating a user sentiment metric for the user using events occurring prior to and during the unit of time, including events obtained from the user history information; and
applying the user sentiment metric to an application.

12. The medium of claim 11, wherein the method further comprises:
receiving the user identifier of the user and one or more events; and
updating the user history information associated with the user in the user history data resource with the one or more events.

13. The medium of claim 11, wherein the generating of the user sentiment metric for the user comprises:
obtaining the user history information associated with the user; and
for each event in the user history information:
obtaining event parameters associated with the event identifier; and
determining an event score for the event based on the obtained event parameters and an amount of time from the timestamp; and
generating the user sentiment metric based on a sum of each of the determined event scores.

14. The medium of claim 13, wherein the event parameters comprise an initial emotional response parameter, a multiplier parameter, a memory parameter, or a combination thereof, wherein the multiplier parameter is based on a frequency of an event in the user history information, wherein the memory parameter is a rate of decay of user emotional response to an event.

15. The medium of claim 11, wherein the unit of time is a time of a timestamp of a received event, such that each time a new event is received, the user sentiment metric is generated.

16. A system comprising:
a processing system;
a storage system;
a user history data resource associated with the storage system;
a data set stored on the user history data resource, the data set providing user history information associated with a user having a user identifier, the user history information comprising a plurality of events, each event having an event identifier and a timestamp; and
instructions stored on the storage system that, when executed by the processing system, direct the processing system to:
for a unit of time, generate a user sentiment metric for the user using events occurring prior to and during the unit of time, including events obtained from the user history information; and
apply the user sentiment metric to an application.

17. The system of claim 16, wherein the instructions further direct the processing system to:
receive the user identifier of the user and one or more events; and
update the user history information associated with the user in the user history data resource with the one or more events.

18. The system of claim 16, wherein the instructions to generate a user sentiment metric for the user direct the processing system to:
obtain the user history information associated with the user; and
for each event in the user history information:
obtain event parameters associated with the event identifier; and
determine an event score for the event based on the obtained event parameters and an amount of time from the timestamp; and
generate the user sentiment metric based on a sum of each of the determined event scores.

19. The system of claim 18, wherein the event parameters comprise an initial emotional response parameter, a multiplier parameter, a memory parameter, or a combination thereof, wherein the multiplier parameter is based on a frequency of an event in the user history information, wherein the memory parameter is a rate of decay of user emotional response to an event.

20. The system of claim 16, wherein the unit of time is a day.
